(19) United States
(12) Patent Application Publication
(10) Pub. No.: US 2025/0367717 A1
(43) Pub. Date: Dec. 4, 2025

(54) METHOD AND APPARATUS FOR RECYCLING VEHICLE WASTE MATERIAL, AND RECYCLED PRODUCT

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, Suwon-si (KR)

(72) Inventors: Dae Sung JUNG, Hwaseong-si (KR); Jae Hoon KIM, Seongnam-si (KR); Sabrinna WULANDARI, Suwon-si (KR); Aye Aye MYINT, Suwon-si (KR); Jong Ho CHOI, Suwon-si (KR)

(21) Appl. No.: 18/812,784

(22) Filed: Aug. 22, 2024

(30) Foreign Application Priority Data
May 29, 2024 (KR) 10-2024-0069962

(51) Int. Cl. B09B 3/80; B01D 11/02; B09B 101/75; B29B 17/02; B29K 105/26; C08J 11/08

(52) U.S. Cl. CPC B09B 3/80; B01D 11/0203; B01D 11/0219; B01D 11/028; B01D 11/0288; B29B 17/02; C08J 11/08; B09B 2101/75; B29B 2017/0293; B29K 2105/26; C08J 2323/12

(57) ABSTRACT

Disclosed are a method and apparatus for recycling a vehicle waste material, and a recycled product, the method including treating a pulverized vehicle waste material placed in a container by allowing a supercritical fluid to flow in the container under conditions of a predetermined temperature, pressure, and time and obtaining the pulverized vehicle waste material, in which the pulverized vehicle waste material before the treating of the pulverized vehicle waste material includes polymers and volatile organic compounds, and a total content of C6-C16 volatile organic compounds in the pulverized vehicle waste material in step (b) is 5,000 μg/m³ or less.

### CROSS-REFERENCE TO RELATED APPLICATION

This application claims, under 35 U.S.C. § 119 (a), the benefit of priority from Korean Patent Application No. 10-2024-0069962, filed on May 29, 2024, the entire contents of which are incorporated herein by reference.

### BACKGROUND

### (a) Technical Field

The present disclosure relates to a method and apparatus for recycling a vehicle waste material, and a recycled product.

### (b) Background

Recently, thorough research and development on recycling of steel, aluminum, and polymers has been carried out to achieve carbon neutrality and circular economy goals. In particular, regulations requiring the content of recycled plastics to be 25 wt % in the draft European scrap legislation announced in the second half of 2023 are being reviewed.

Recycled plastics are mainly applied to exterior parts of a vehicle, such as a vehicle wheel guard, undercover, etc., and application thereof to interior parts is limited due to issues with odor, volatile organic compounds (VOCs), and color.

As recycled plastics are subjected to a recycling process, some chemical solvents in polymers may remain and some polymer chains are broken through thermal deformation such as extrusion, etc., resulting in low-molecular-weight materials, which may not meet VOC and odor standards.

Vacuum degassing or the like may be performed to reduce hazardous materials such as VOCs, etc. in recycled plastics, but there are limits to the removal of materials with low vapor pressure and materials that have interacted with the matrix of thermoplastic polymers. Moreover, when using a stripping agent, there is a risk of decomposing the matrix of the thermoplastic polymer during high-temperature processing, and it is difficult to remove materials that are polar in contrast to the stripping agent, and additional processes may be required to remove the remaining stripping agent.

### SUMMARY

The present disclosure has been made keeping in mind the problems encountered in the related art, and an object of the present disclosure is to provide a method of removing volatile organic compounds (VOCs) from vehicle waste materials using a supercritical fluid under specific conditions.

Another object of the present disclosure is to provide a method of manufacturing recycled products and vehicle recycled products that satisfy VOC detection standards.

The objects of the present disclosure are not limited to the foregoing. The objects of the present disclosure will be able to be clearly understood through the following description and to be realized by the means described in the claims and combinations thereof.

An aspect of the present disclosure provides a method of recycling a vehicle waste material, including (a) treating a pulverized vehicle waste material placed in a container by allowing a supercritical fluid to flow in the container under conditions of a predetermined temperature, pressure, and time and (b) obtaining the pulverized vehicle waste material subjected to step (a) (S10), in which the pulverized vehicle waste material before step (a) includes polymers and volatile organic compounds, and a total content of C6-C16 volatile organic compounds in the pulverized vehicle waste material in step (b) (S20) is 5,000 μg/m³ or less.

Another aspect of the present disclosure provides an apparatus for recycling a vehicle waste material, including a container configured to have an internal space that accommodates a pulverized vehicle waste material and a supercritical fluid and enable flow treatment with the supercritical fluid under conditions of a predetermined temperature, pressure, and time, a retention unit configured to communicate with the container and store the supercritical fluid discharged from the container, and a feeder configured to communicate with the container and supply the supercritical fluid to the container, in which the pulverized vehicle waste material before treatment with the supercritical fluid includes polymers and volatile organic compounds, and a total content of C6-C16 volatile organic compounds in the pulverized vehicle waste material obtained after treatment with the supercritical fluid in the container is 5,000 μg/m³ or less.

Still another aspect of the present disclosure provides a recycled product, obtained by treating a pulverized vehicle waste material including polymers and volatile organic compounds with a supercritical fluid under conditions of a predetermined temperature, pressure, and time, in which a total content of C6-C16 volatile organic compounds is 5,000 μg/m³ or less.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 schematically shows an apparatus for recycling a vehicle waste material according to an aspect of the present disclosure;

FIG. 2 depicts a top graph showing the concentration of each component according to Comparative Examples depending on the supercritical fluid process temperature conducted in Test Example 2, and a bottom graph showing the removal rate of each component according to Comparative Examples depending on the supercritical fluid process temperature;

FIG. 3 depicts a top graph showing the concentration of each component according to Comparative Examples depending on the supercritical fluid process pressure conducted in Test Example 3, and a bottom graph showing the removal rate of each component according to Comparative Examples depending on the supercritical fluid process pressure;

FIG. 4 depicts a top graph showing the concentration of each component according to Comparative Examples depending on the supercritical fluid process time conducted in Test Example 4, and a bottom graph showing the removal rate of each component according to Comparative Examples depending on the supercritical fluid process time;

FIG. 5 is a flowchart showing a process of recycling a vehicle waste material according to an aspect of the present disclosure; and

FIG. 6 is a flowchart showing a process of recycling a vehicle waste material according to another aspect of the present disclosure.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

### Method of Recycling Vehicle Waste Material

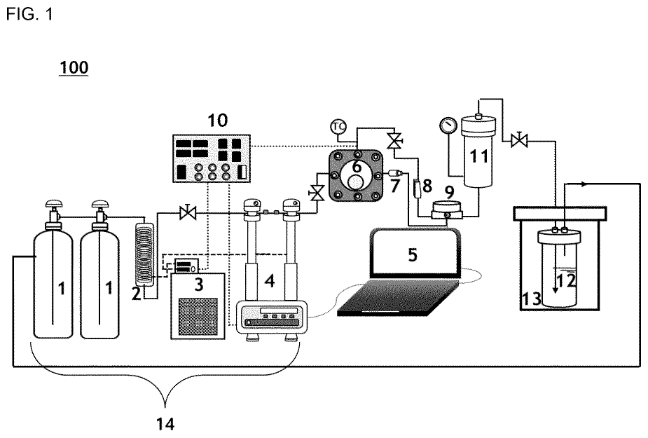

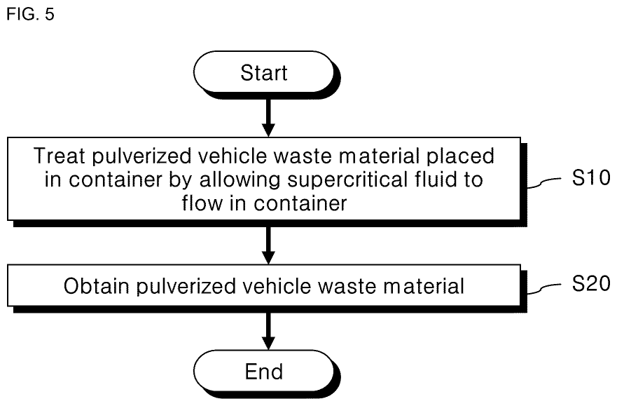

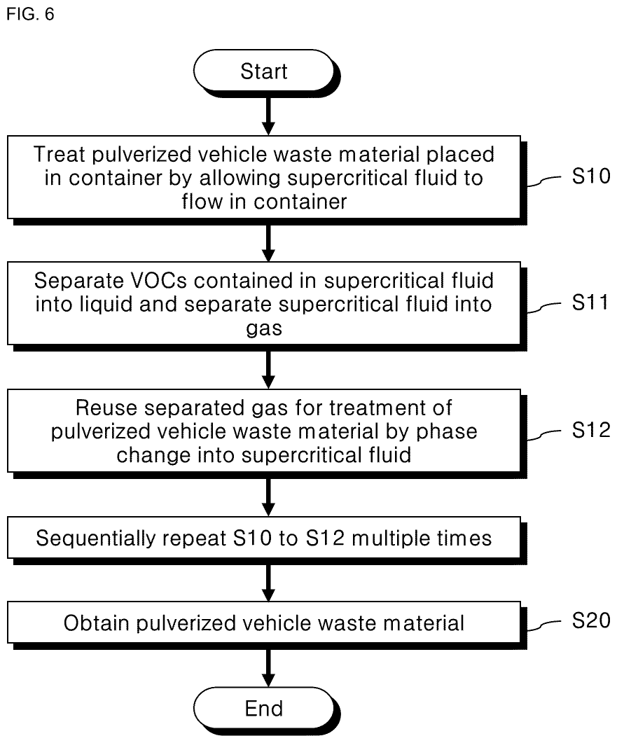

Referring to FIGS. 1, 5, and 6, a method of recycling a vehicle waste material according to an aspect of the present disclosure includes (a) treating a pulverized vehicle waste material placed in a container by allowing a supercritical fluid to flow in the container under conditions of a predetermined temperature, pressure, and time (S10), and (b) obtaining the pulverized vehicle waste material subjected to step (a) (S10) (S20).

Here, the pulverized vehicle waste material before step (a) (S10) may include polymers and volatile organic compounds, and a total content of C6-C16 volatile organic compounds in the pulverized vehicle waste material in step (b) (S20) may be 5,000 μg/m³ or less.

The pulverized vehicle waste material in step (a) (S10) may be derived from vehicle exterior materials mainly including polymers, and may include, for example, a pulverized material of any one selected from the group consisting of a bumper, a wheel guard, a grille, an undercover, and other pulverizable vehicle exterior materials, and combinations thereof. The polymer is not particularly limited and may include a thermoplastic polymer used for vehicle parts. Examples thereof may include polyolefin (polyethylene, polypropylene), polycarbonate, polyester, polyurethane (TPU), polyamide, polyimide, polymethyl methacrylate, polysulfone, polyvinyl chloride, rubber, and the like.

The pulverized vehicle waste material in step (a) (S10) may not substantially contain metal, and some metal components may be separated. An example of the separation process may include magnetic separation, etc.

The pulverized vehicle waste material in step (a) (S10) may be a vehicle waste material that has been pulverized to a predetermined size, and may have a size suitable for placement in a container that may be treated with supercritical fluid. For example, the maximum size thereof may be 10 cm or less.

The pulverized vehicle waste material in step (a) (S10) may include a pulverized material of any one selected from the group consisting of a bumper, a wheel guard, a grille, an undercover, other pulverizable vehicle exterior materials, and combinations thereof.

Step (a) (S10) may include processing the pulverized vehicle waste material for more effective VOC reduction. For example, step (a) (S10) may further include forming an extrudate by melting the pulverized vehicle waste material and extruding the same into a predetermined shape. Here, the extrudate may have a pellet shape, a flake shape, a spherical shape, a polygonal shape, etc.

The maximum size of the extrudate in step (a) (S10) may be 3 cm or less, or 2 cm or less, and 0.01 cm or more. When the pulverized vehicle waste material is processed to such an extrudate size, the removal of volatile organic compounds by the supercritical fluid in the subsequent step may more effectively proceed.

When the processing described above proceeds in step (a) (S10), subsequent supercritical fluid treatment may be performed on the extrudate.

The volatile organic compounds (VOCs) are a group of specific organic compounds and may include benzene, toluene, ethylbenzene, xylene, styrene, formaldehyde, acrolein, etc., and may further include C6-C16 organic compounds in addition to the components listed above.

The pulverized vehicle waste material in step (a) (S10) may include not only the volatile organic compounds (VOCs) but also other odor-causing materials, which may be removed through a subsequent step.

The supercritical fluid in step (a) (S10) may include carbon dioxide, ethane, ethylene, propane, propylene, etc., and preferably includes carbon dioxide that is easy to separate after treatment.

The supercritical fluid in step (a) (S10) may include or may be replaced with a subcritical fluid depending on the situation. A subcritical fluid may be a fluid (gas or liquid) which has a temperature and pressure higher than the triple point of the relevant material and in which either the temperature or the pressure at the critical point does not exceed the critical point.

The temperature in step (a) (S10) may be 50° C. to 120° C., or 60° C. to 100° C. If the temperature is less than 50° C., the removal efficiency of volatile organic compounds may decrease, whereas if the temperature exceeds 120° C., excessive energy may be consumed to maintain the supercritical fluid, and even if the temperature is further raised, there may be no significant difference in reducing volatile organic compounds.

The pressure in step (a) (S10) may be 8 MPa to 30 MPa, 10 MPa to 25 MPa, or 15 MPa to 20 MPa. If the pressure is less than 8 MPa, the removal efficiency of volatile organic compounds may decrease, whereas if the pressure exceeds 30 MPa, the removal efficiency of some components of volatile organic compounds may decrease.

The treatment time in step (a) (S10) may be 1.5 hours to 6 hours, 2 hours to 5.5 hours, or 3 hours to 5 hours. If the treatment time is less than 1.5 hours, the removal of volatile organic compounds may be not sufficient, whereas if the treatment time exceeds 6 hours, excessive energy may be consumed, and even with a longer treatment time, there may be no significant difference in reducing volatile organic compounds.

The flow rate of the supercritical fluid in step (a) (S10) may be 5 ml/min to 100 ml/min, or 10 ml/min to 50 ml/min. When the flow rate of the supercritical fluid falls in the above range, volatile organic compounds included in the pulverized vehicle waste material may be easily extracted and removal efficiency thereof may be increased.

In step (a) (S10), the weight of the pulverized vehicle waste material to which the above flow rate may be applied may be 0.01 kg to 500 kg.

Step (b) (S20) may be performed by stopping the supply of the supercritical fluid after step (a), removing the supercritical fluid, and then taking out the pulverized vehicle waste material from the container.

The total content of C6-C16 total volatile organic compounds (TVOCs) in the pulverized vehicle waste material obtained in step (b) (S20) may be 5,000 μg/m³ or less, 3,000 μg/m³ or less, or 1,000 μg/m³ or less, and 10 μg/m³ or more.

The content of each of specific volatile organic compounds in the pulverized vehicle waste material obtained in step (b) (S20) may be equal to or less than a certain level μg/m³, which is as described in a recycled product described later.

Measurement of the content of volatile organic compounds (VOCs) may be performed by liquid chromatography (HPLC), gas chromatography-mass spectrometry (GC-MS), etc. according to MS300-55. Alternatively, measurement may be performed according to ASTM D7706, ISO 12219-3, etc.

The supercritical fluid may be continuously supplied to and discharged from the container in step (a). For example, the supercritical fluid may be supplied from a feeder in communication with the container, and the supplied supercritical fluid may be discharged to a retention unit in communication with the container.

Step (a) (S10) may further include (a1) separating the volatile organic compounds included in the supercritical fluid discharged in step (a) (S10) into liquid and separating the supercritical fluid into gas by phase change (S11) and (a2) reusing the gas separated in step (a1) (S11) as the supercritical fluid of step (a) by performing phase change into a supercritical fluid (S12).

Here, steps (a), (a1), and (a2) (S10, S11, S12) may be sequentially repeated multiple times, after which step (b) may be performed, and raw components of the supercritical fluid may be circulated.

Steps (a1) and (a2) may be performed through a gas-liquid separator in communication with the retention unit, and a feeder that is in communication with the gas-liquid separator and includes a phase change unit.

In the method of recycling the vehicle waste material according to an aspect of the present disclosure, based on the total content of C6-C16 volatile organic compounds (TVOCs) included in the pulverized vehicle waste material, the C6-C16 volatile organic compound removal rate of the pulverized vehicle waste material subjected to step (a) may be 70% or more, 85% or more, or 95% or more, and 99.9% or less. Here, the specific component removal rate of the pulverized vehicle waste material is calculated as follows.

Specific component removal rate=(Difference in specific component content of pulverized vehicle waste material (extrudate) before and after treatment/Specific component content of pulverized vehicle waste material (extrudate) before treatment)*100%

Also, based on xylene contained in the pulverized vehicle waste material, the xylene removal rate of the pulverized vehicle waste material subjected to step (a) may be 85 wt % or more, or 97 wt % or more, and 99.99 wt % or less.

Also, based on styrene contained in the pulverized vehicle waste material, the styrene removal rate of the pulverized vehicle waste material subjected to step (a) may be 90 wt % or more, or 98 wt % or more, and 99.99 wt % or less.

The method of recycling the vehicle waste material according to an aspect of the present disclosure is capable of more easily removing volatile organic compounds from the pulverized vehicle waste material by supercritical fluid treatment compared to simple degassing or heat treatment. The pulverized vehicle waste material treated with supercritical fluid and a recycled product may be reused for various purposes.

### Apparatus 100 for Recycling Vehicle Waste Material

Referring to FIG. 1, an apparatus 100 for recycling a vehicle waste material according to another aspect of the present disclosure may include a container 6 configured to have an internal space that accommodates a pulverized vehicle waste material and a supercritical fluid and enable flow treatment with the supercritical fluid under conditions of a predetermined temperature, pressure, and time, a retention unit 11 configured to communicate with the container 6 and store the supercritical fluid discharged from the container 6, and a feeder 14 configured to communicate with the container 6 and supply the supercritical fluid to the container 6.

Here, the pulverized vehicle waste material before treatment with the supercritical fluid may include polymers and volatile organic compounds, and a total content of C6-C16 volatile organic compounds (TVOCs) in the pulverized vehicle waste material obtained after treatment with the supercritical fluid in the container 6 may be 5,000 μg/m³ or less.

The container 6 may correspond to a so-called view cell. The container 6 is capable of opening or closing the internal space as needed, and the pulverized vehicle waste material, an extrudate obtained by melting and extruding the same, etc., may be placed therein.

The feeder 14 may specifically include a storage unit 1 configured to store a gas medium, a cooling unit 2 configured to communicate with the storage unit 1 and cool the gas medium, and a phase change unit 4 configured to communicate with the cooling unit 2 and phase change the cooled medium into a supercritical fluid by controlling the temperature and pressure thereof, and the phase change unit 4 in the feeder 14 may be in communication with the container 6.

The cooling unit 2 may include a pipe through which a coolant circulates, compresses, and expands in an internal space, and in this internal space, the gas medium may be adjusted to a predetermined temperature and liquefied into a liquid medium. The pipe may communicate with a circulation unit 3 so that the coolant may circulate.

The cooling unit 2 and the phase change unit 4 may be connected to a controller 10. The controller 10 may serve to monitor the status of the cooling unit 2 and the phase change unit 4 and control respective temperatures and pressures. The controller 10 may be connected to a computer 5, through which pressure and temperature may be controlled with a more convenient user interface.

As described in the method of recycling the waste material, when treating the pulverized vehicle waste material with the supercritical fluid, the described temperature and pressure conditions may be applied through the phase change unit 4, and also substantially the same temperature and pressure may be maintained in the container 6. Also, the flow path in communication with the phase change unit 4 and the container 6 and the flow path in communication with the retention unit 11 and the container 6 may each further include a valve, and the flow rate may be controlled.

A pressure regulator 9 may be provided in the flow path in communication with the container 6 and the retention unit 11, and may serve to adjust the pressure of the supercritical fluid discharged from the container 6 to the retention unit 11. The pressure regulator 9 may serve to check the pressure state of the container 6 using a pressure sensor 7 in a separate flow path.

A filter 8 may be provided in the flow path in communication with the container 6 and the pressure regulator 9, and may serve to filter unnecessary solid impurities discharged from the container 6.

The retention unit 11 may be in communication with a gas-liquid separator 12, and the gas-liquid separator 12 may be in communication with the feeder 14, and may be in communication with the storage unit 1 of the feeder 14.

The gas-liquid separator 12 may serve to phase change the supercritical fluid transferred from the retention unit 11 into gas and phase change volatile organic compounds that are solutes in the supercritical fluid into liquid to separate individual materials. The phase-changed gas may be transferred to the storage unit 1 of the feeder 14.

The gas-liquid separator 12 may be included in an air bath 13.

### Recycled Product

Still another aspect of the present disclosure relates to a recycled product, obtained by treating a pulverized vehicle waste material including polymers and volatile organic compounds (VOCs) with a supercritical fluid under conditions of a predetermined temperature, pressure, and time, in which the total content of C6-C16 volatile organic compounds may be 5,000 μg/m³ or less.

The supercritical fluid treatment is as described in the method of recycling the vehicle waste material above, and thus a redundant description thereof will be omitted.

The recycled product may have a benzene content of 30 μg/m³ or less, a toluene content of 1,000 μg/m³ or less, an ethylbenzene content of 1,000 μg/m³ or less, a xylene content of 870 μg/m³ or less, a styrene content of 220 μg/m³ or less, a formaldehyde content of 210 μg/m³ or less, an acetaldehyde content of 300 μg/m³ or less, and an acrolein content of 50 μg/m³ or less. The content of each of the above components may be 5 μg/m³ or more.

The volatile organic compound content of the recycled product may be measured as described in the method of recycling the waste material above.

The recycled product may be reused for vehicle interior and exterior materials, vehicle parts, and other polymer-applied items.

A better understanding of the present disclosure may be obtained through the following examples and comparative examples. However, these examples are not to be construed as limiting the technical spirit of the present disclosure.

### Example 1

(a) An extrudate was formed by melting a pulverized vehicle waste bumper including polypropylene and extruding the same into pellets with a maximum size of 2 cm or less. The extrudate was placed in a container and treated by allowing a carbon dioxide supercritical fluid to flow in the container at a temperature of 60° C., a pressure of 25 MPa, and a flow rate of 30 ml/min for 6 hours. The carbon dioxide supercritical fluid was supplied to the container from a feeder and discharged to a retention unit from the container.

(b) After step (a), the flow of the supercritical fluid was stopped, the remaining supercritical fluid was removed, and the extrudate was taken out from the container.

### Example 2-1

An extrudate was obtained under the same conditions as in Example 1, with the exception that the pressure in step (a) was changed to 10 MPa.

### Example 2-2

An extrudate was obtained under the same conditions as in Example 1, with the exception that the pressure in step (a) was changed to 15 MPa.

### Example 2-3

An extrudate was obtained under the same conditions as in Example 1, with the exception that the pressure in step (a) was changed to 20 MPa.

### Example 3-1

An extrudate was obtained under the same conditions as in Example 1, with the exception that the temperature in step (a) was changed to 40° C.

### Example 3-2

An extrudate was obtained by performing Example 1 again.

### Example 3-3

An extrudate was obtained under the same conditions as in Example 1, with the exception that the temperature in step (a) was changed to 80° C.

### Example 3-4

An extrudate was obtained under the same conditions as in Example 1, with the exception that the temperature in step (a) was changed to 100° C.

### Example 4-1

An extrudate was obtained under the same conditions as in Example 1, with the exception that the treatment time in step (a) was changed to 1 hour.

### Example 4-2

An extrudate was obtained under the same conditions as in Example 1, with the exception that the treatment time in step (a) was changed to 2 hours.

### Example 4-3

An extrudate was obtained under the same conditions as in Example 1, with the exception that the treatment time in step (a) was changed to 3 hours.

### Example 4-4

An extrudate was obtained under the same conditions as in Example 1, with the exception that the treatment time in step (a) was changed to 4 hours.

### Example 4-5

An extrudate was obtained under the same conditions as in Example 1, with the exception that the treatment time in step (a) was changed to 5 hours.

### Reference Example 1

A waste bumper extrudate treated with a supercritical fluid was obtained under the same conditions as in Example 1, with the exception that the pulverized vehicle waste bumper in step (a) was extruded in a bulk form greater than 2 cm, the temperature was changed to 160° C., and the treatment time was changed to 2 minutes.

### Reference Example 2

An extrudate was obtained under the same conditions as in Example 1, with the exception that the pressure in step (a) was changed to 5 MPa.

### Comparative Example 1 (CE 1)

A vehicle waste bumper extrudate including polypropylene was provided, and was not treated with a separate supercritical fluid.

### Comparative Example 2 (CE 2)

A waste bumper extrudate was obtained by placing a vehicle waste bumper extrudate including polypropylene in a container and performing heat treatment at 60° C. for 6 hours.

### Comparative Example 3 (CE 3)

A waste bumper extrudate was obtained by placing a vehicle waste bumper extrudate including polypropylene in a container and performing heat treatment at 160° C. for 2 minutes.

The conditions of Examples, Comparative Examples, and Reference Examples are shown in Table 1 below.

TABLE 1

| | | (a) | (a) | (a) |
|---|---|---|---|---|
| | | Temperature | Pressure | Time |
| Classification | (a) Treatment means | (° C.) | (MPa) | (h) |
| Example 1 | Supercritical fluid | 60 | 25 | 6 |
| Reference | Supercritical fluid | 160 | 25 | 2 min |
| Example 1 | | | | |
| Reference | Subcritical fluid | 60 | 5 | 6 |
| Example 2 | | | | |
| Example 2-1 | Supercritical fluid | 60 | 15 | 6 |
| Example 2-2 | Supercritical fluid | 60 | 20 | 6 |
| Example 2-3 | Supercritical fluid | 60 | 25 | 6 |
| Example 3-1 | Supercritical fluid | 40 | 25 | 6 |
| Example 3-2 | Supercritical fluid | 60 | 25 | 6 |
| Example 3-3 | Supercritical fluid | 80 | 25 | 6 |
| Example 3-4 | Supercritical fluid | 100 | 25 | 6 |
| Example 4-1 | Supercritical fluid | 60 | 25 | 1 |
| Example 4-2 | Supercritical fluid | 60 | 25 | 2 |
| Example 4-3 | Supercritical fluid | 60 | 25 | 3 |
| Example 4-4 | Supercritical fluid | 60 | 25 | 4 |
| Example 4-5 | Supercritical fluid | 60 | 25 | 5 |
| Comparative | — | — | — | — |
| Example 1 | | | | |
| Comparative | Heat treatment | 60 | — | 6 |
| Example 2 | | | | |
| Comparative | Heat treatment | 160 | — | 2 min |
| Example 3 | | | | |

### Test Example 1-Measurement of VOC Removal Rate Depending on Presence or Absence of Supercritical Fluid Treatment and Object Processing

The VOC contents of the products of Comparative Examples 1 to 3, Reference Example 1, and Example 2-1 were determined by gas chromatography-mass spectrometry (GC-MS) and high-performance liquid chromatography (HPLC) according to MS-300-55, and the results thereof are shown in Table 2 below.

TABLE 2

| | Comparative | Comparative | Comparative | | Reference |
|---|---|---|---|---|---|
| Classification | Example 1 | Example 2 | Example 3 | Example 2-1 | Example 1 |
| Treatment | No treatment | 60° C. heating | 160° C. heating | Pellet | Bulk |
| conditions | | | | extrudate | extrudate |
| | | | | ScCO₂ | ScCO₂ |
| Benzene | ND | ND | ND | 3 | ND |
| Toluene | 207 | 169 | 205 | 23 | 25 |
| Ethyl benzene | 532 | 338 | 308 | 9 | 39 |
| Xylene | 4014 | 2529 | 2118 | 78 | 367 |
| Styrene | 416 | 275 | 275 | 6 | 30 |
| Formaldehyde | 73 | 125 | 163 | 34 | 95 |
| Acetaldehyde | 6 | 28 | 28 | 8 | 23 |
| Acrolein | ND | 6 | ND | ND | ND |
| TVOCs | 14897 | 6084 | 6087 | 559 | 4869 |
| (C6-C16) | | | | | |

Unit: μg/m³,
ND: below detection limit,
ScCO₂: Supercritical fluid carbon dioxide

Referring thereto, Example in which the extrudate was processed into pellets showed higher TVOC (C6-C16) removal efficiency, and Comparative Examples in which the supercritical fluid was not applied showed a TVOC (C6-C16) content of 5,000 μg/m³ or more. Reference Example 1, in which the extrudate was not processed into pellets and the treatment time was short, showed a relatively high TVOC (C6-C16) content.

### Test Example 2-Measurement of VOC Removal Rate Depending on Supercritical Fluid Treatment Temperature

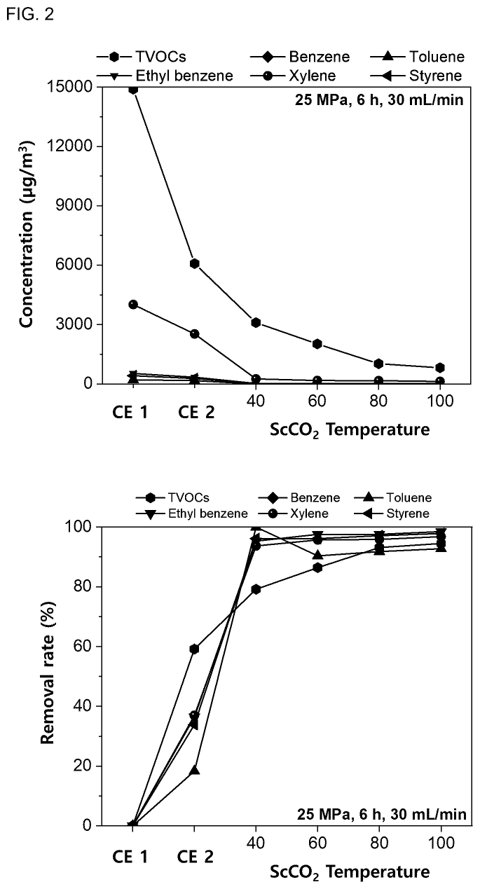

The VOC contents of the products of Examples 3-1 to 3-4 were measured in the same manner as in Test Example 1, and the results thereof are shown in Table 3 below and FIG. 2. The removal rate was calculated as follows. Specific component removal rate=(Difference in specific component content of pulverized vehicle waste material (extrudate) before and after treatment/Specific component content of pulverized vehicle waste material (extrudate) before treatment)*100%

TABLE 3

| | Comparative | | | | |
|---|---|---|---|---|---|
| Classification | Example 2 | Example 3-1 | Example 3-2 | Example 3-3 | Example 3-4 |
| Treatment | 60° C. heating | 40° C. | 60° C. | 80° C. | 100° C. |
| conditions | | ScCO₂ | ScCO₂ | ScCO₂ | ScCO₂ |
| Benzene | ND | ND | ND | ND | ND |
| Toluene | 169 | ND | 20 | 17 | 15 |
| Ethyl benzene | 338 | 25 | 13 | 13 | 8 |
| Xylene | 2529 | 253 | 172 | 166 | 128 |
| Styrene | 275 | 16 | 16 | 12 | 9 |
| Formaldehyde | 125 | 132 | 91 | 52 | 79 |
| Acetaldehyde | 28 | ND | ND | ND | ND |
| Acrolein | 6 | ND | 52 | ND | ND |
| TVOCs | 6084 | 3101 | 2025 | 1022 | 820 |
| (C6-C16) | | | | | |

Unit: μg/m³,
ND: below detection limit,
ScCO₂: Supercritical fluid carbon dioxide

Referring thereto, in Examples 3-1 to 3-4 compared to Comparative Example 2 in which simple heat treatment was performed without supercritical fluid treatment, the overall VOC content was low, the removal rate was high, and the contents of VOCs and TVOCs (C6-C16) were decreased with an increase in the temperature.

### Test Example 3-Measurement of VOC Removal Rate Depending on Supercritical Fluid Treatment Pressure

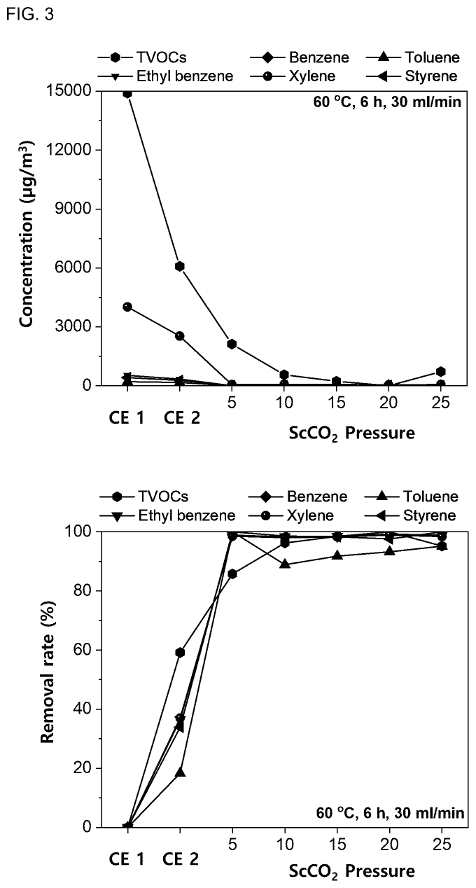

The VOC contents of the products of Examples 2-1 to 2-3, Example 1, and Reference Example 2 were measured in the same manner as in Test Example 1, and the results thereof are shown in Table 4 below and FIG. 3.

TABLE 4

| | Comparative | Reference | Example | Example | Example | Example |
|---|---|---|---|---|---|---|
| Classification | Example 2 | Example 2 | 2-1 | 2-2 | 2-3 | 1 |
| Treatment | 60° C. | 5 MPa | 10 MPa | 15 MPa | 20 MPa | 25 MPa |
| conditions | heating | CO₂ | ScCO₂ | ScCO₂ | ScCO₂ | ScCO₂ |
| Benzene | ND | ND | 3 | 17 | ND | ND |
| Toluene | 169 | ND | 23 | 17 | 14 | 10 |
| Ethyl benzene | 338 | 6 | 9 | 8 | 4 | 6 |
| Xylene | 2529 | 59 | 78 | 70 | 44 | 64 |
| Styrene | 275 | ND | 6 | 7 | 10 | ND |
| Formaldehyde | 125 | 15 | 34 | 103 | ND | 122 |
| Acetaldehyde | 28 | 7 | 8 | 24 | 1 | 29 |
| Acrolein | 6 | 4 | ND | ND | ND | 7 |
| TVOCs (C6-C16) | 6084 | 2121 | 559 | 228 | 179 | 718 |

Unit: μg/m³,
ND: below detection limit,
ScCO₂: Supercritical fluid carbon dioxide

Referring thereto, in Examples 2-1 to 2-3 and Example 1 compared to Comparative Examples, the overall VOC content was low, and the TVOC (C6-C16) content was 1,000 μg/m³ or less at 10 MPa to 25 MPa. In Reference Example 2, a so-called subcritical fluid (gas) slightly lower than the critical pressure of carbon dioxide was applied.

### Test Example 4-Measurement of VOC Removal Rate Depending on Supercritical Fluid Treatment Time

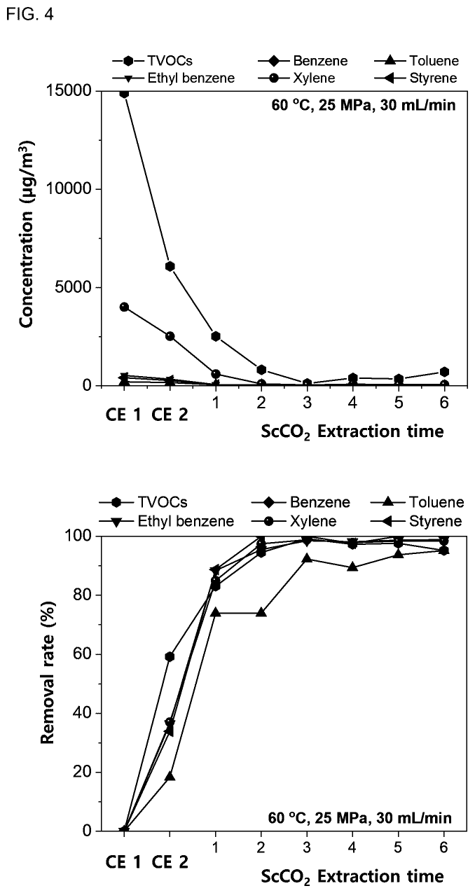

The VOC contents of the products of Examples 4-1 to 4-5 were measured in the same manner as in Test Example 1, and the results thereof are shown in Table 5 below and FIG. 4.

TABLE 5

| | Comparative | Example | Example | Example | Example | Example | Example |
|---|---|---|---|---|---|---|---|
| Classification | Example 2 | 4-1 | 4-2 | 4-3 | 4-4 | 4-5 | 1 |
| Treatment | 60° C. | 1 hour | 2 hours | 3 hours | 4 hours | 5 hours | 6 hours |
| conditions | heating | ScCO₂ | ScCO₂ | ScCO₂ | ScCO₂ | ScCO₂ | ScCO₂ |
| Benzene | ND | ND | ND | ND | ND | ND | ND |
| Toluene | 169 | 54 | 54 | 16 | 22 | 13 | 10 |
| Ethyl benzene | 338 | 62 | 24 | 8 | 10 | 7 | 6 |
| Xylene | 2529 | 604 | 102 | 48 | 86 | 65 | 64 |
| Styrene | 275 | 47 | ND | ND | 10 | ND | ND |
| Formaldehyde | 125 | 114 | 111 | ND | 63 | 105 | 122 |
| Acetaldehyde | 28 | 32 | 36 | ND | 18 | 19 | 29 |
| Acrolein | 6 | 5 | ND | ND | 2 | ND | 7 |
| TVOCs(C6-C16) | 6084 | 2527 | 821 | 123 | 403 | 354 | 718 |

Unit: μg/m³,
ND: below detection limit,
ScCO₂: Supercritical fluid carbon dioxide

Referring thereto, in Examples 4-1 to 4-5 and Example 1 compared to Comparative Examples, the overall VOC content was low, and the TVOC (C6-C16) content was 1,000 μg/m³ or less for 2 to 6 hours.

As is apparent from the above description, according to the present disclosure, volatile organic compounds in vehicle waste materials can be removed to a certain level or less, and recycled products that satisfy VOC detection standards can be obtained.

In addition, recycled products can have very low volatile organic compound detection levels compared to when performing simple heat treatment, and recycled products can be applied not only to vehicle exterior materials but also to various end uses.

The effects of the present disclosure are not limited to the foregoing. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A method of recycling a vehicle waste material, comprising:
(a) treating a pulverized vehicle waste material placed in a container by allowing a supercritical fluid to flow within the container under conditions of a predetermined temperature, pressure, and time; and
(b) obtaining the pulverized vehicle waste material subjected to the step of treating a pulverized vehicle waste material,
wherein the pulverized vehicle waste material before the treating a pulverized vehicle waste material comprises polymers and volatile organic compounds, and
a total content of C6-C16 volatile organic compounds in the pulverized vehicle waste material in the obtaining the pulverized vehicle waste material is 5,000 μg/m³ or less.

2. The method of claim 1, wherein the step of treating a pulverized vehicle waste material further comprises forming an extrudate by melting the pulverized vehicle waste material and performing extrusion in a predetermined shape.

3. The method of claim 2, wherein the extrudate has a maximum size of 3 cm or less.

4. The method of claim 1, wherein the volatile organic compounds comprise benzene, toluene, ethylbenzene, xylene, styrene, formaldehyde, acetaldehyde, and acrolein.

5. The method of claim 1, wherein the supercritical fluid in the step of treating a pulverized vehicle waste material comprises carbon dioxide.

6. The method of claim 1, wherein the temperature in step (a) is 50° C. to 120° C.

7. The method of claim 1, wherein the pressure in the step of treating a pulverized vehicle waste material is 8 MPa to 30 MPa.

8. The method of claim 1, wherein the treatment time in the step of treating a pulverized vehicle waste material is 1.5 to 6 hours.

9. The method of claim 1, wherein a flow rate of the supercritical fluid in the step of treating a pulverized vehicle waste material is 5 ml/min to 100 ml/min.

10. The method of claim 1, wherein:
the supercritical fluid is continuously supplied to and discharged from the container in the step of treating a pulverized vehicle waste material, and
the step of treating a pulverized vehicle waste material further comprises (a1) separating the volatile organic compounds contained in the supercritical fluid discharged in the step of treating a pulverized vehicle waste material into liquid and separating the supercritical fluid into gas by phase change.

11. The method of claim 10, wherein:
the step of (a) treating a pulverized vehicle waste material further comprises (a2) reusing the gas separated in step (a1) as the supercritical fluid of step (a) by performing phase change into a supercritical fluid, and
the steps (a), (a1), and (a2) are sequentially repeated multiple times, and then step (b) is performed.

12. An apparatus for recycling a vehicle waste material, comprising:
a container configured to have an internal space that accommodates a pulverized vehicle waste material and a supercritical fluid and enable flow treatment with the supercritical fluid under conditions of a predetermined temperature, pressure, and time;
a retention unit configured to communicate with the container and store the supercritical fluid discharged from the container; and
a feeder configured to communicate with the container and supply the supercritical fluid to the container,
wherein the pulverized vehicle waste material before treatment with the supercritical fluid comprises polymers and volatile organic compounds, and
a total content of C6-C16 volatile organic compounds in the pulverized vehicle waste material obtained after treatment with the supercritical fluid in the container is 5,000 μg/m³ or less.

13. A recycled product, obtained by treating a pulverized vehicle waste material comprising polymers and volatile organic compounds with a supercritical fluid under conditions of a predetermined temperature, pressure, and time, in which a total content of C6-C16 volatile organic compounds is 5,000 μg/m³ or less.

14. The recycled product of claim 13, further comprising:
a benzene content of 30 μg/m³ or less,
a toluene content of 1,000 μg/m³ or less,
an ethylbenzene content of 1,000 μg/m³ or less,
a xylene content of 870 μg/m³ or less,
a styrene content of 220 μg/m³ or less,
a formaldehyde content of 210 μg/m³ or less,
an acetaldehyde content of 300 μg/m³ or less, and
an acrolein content of 50 μg/m³ or less.

15. The recycled product of claim 13, wherein the pulverized vehicle waste material comprises a pulverized material of any one selected from the group consisting of a bumper, a wheel guard, a grille, an undercover, other pulverizable vehicle exterior materials, and combinations thereof.
